(19) United States
(12) Patent Application Publication
(10) Pub. No.: US 2015/0324044 A1
(43) Pub. Date: Nov. 12, 2015

(54) Capacitive touch sensor architecture with adjustable resistance and noise reduction method

(71) Applicant: Inputek Co. Ltd., Hsinchu County (TW)

(72) Inventors: Chi Chin CHEN, Hsinchu County (TW); Tse Yen LIN, Hsinchu County (TW); Han Jung CHEN, Hsinchu County (TW)

(21) Appl. No.: 14/595,362

(22) Filed: Jan. 13, 2015

Related U.S. Application Data
(60) Provisional application No. 61/927,702, filed on Jan. 15, 2014.

(51) Int. Cl. G06F 3/041; G06F 3/047; G06F 3/044

(52) U.S. Cl. CPC G06F 3/0412; G06F 3/044; G06F 3/047; G06F 2203/04103

(57) ABSTRACT

A capacitive touch sensor architecture comprises a visible touch area, a plurality of wires, a plurality of winding resistances, and a reference strip capacity sensor. The visible touch area comprises a plurality of strip capacity sensors. The strip capacity sensors comprises end a and end b. said strip capacity sensors comprises a plurality of non-conductive barriers. The strip capacity sensors being used to sense touch signals to calculate touch point coordinate. The winding resistances are attached to both sides of each said strip capacity sensor. The wires have different length according to the position of each strip capacity sensor the wires are connected to. By adding non-conductive barrier into strip capacity sensors the edge resisting rate can be increased. By adding adjustable winding resistance to the two ends of each strip capacity sensors, the resistance difference can be eliminated.

The current application claims a priority to the U.S. Provisional Patent application Ser. No. 61/927,702 filed on Jan. 15, 2014.

### FIELD OF THE INVENTION

The present invention relates to capacitive touch sensor architecture. More specifically, it is capacitive touch sensor architecture design with adjustable resistance and be able to reduce noise, which guarantee a high touch accuracy.

### BACKGROUND OF THE INVENTION

The touch screen technology has been used in a wide variety of different areas and applications, such as mobile phone, tablet computer, game console, and screens of many other devices. A touch screen is an electronic visual display that the user can control through simple or multi-touch gestures by touching the screen with one or more fingers. Some touch screens can also detect objects such as a stylus or ordinary or specially coated gloves. The touch screen technology is very popular because it enables the user to interact directly with what is displayed, rather than using a mouse, touchpad, or any other intermediate device.

While they all can achieve the same result, there are a variety of different touch screen technologies that can accomplish the touch sensing. These technologies comprise resistive touch panel, surface acoustic wave touch panel, capacitive touch panel, infrared grid touch panel, optical touch panel, etc. Recently, the capacitive touch panels have become more popular after the releases of new smart phones and tablets.

All capacitive touch screens are made up of a matrix of rows and columns of conductive material, layered on sheets of glass. This can be done either by etching a single conductive layer to form a grid pattern of electrodes, or by etching two separate, perpendicular layers of conductive material with parallel lines or tracks to form a grid. Voltage applied to this grid creates a uniform electrostatic field, which can be then measured. When a conductive object, such as a finger, comes into contact with a capacitive touch panel, it distorts the local electrostatic field at that point. This is measurable as a change in capacitance. If a finger bridges the gap between two of the tracks, the charge field can be further accurately interrupted and detected by a microcontroller unit.

The capacitance touch panel can be changed and measured at every individual point on the grid (intersection). Therefore, this system is able to accurately track touches. Due to the top layer of a capacitance touch panel being glass, it is a more robust solution than the less costly resistive touch technology. Additionally, unlike traditional capacitive touch technology, it is possible for a capacitance touch panel system to sense a passive stylus or gloved fingers.

However, due to the noise and the low resistance of the conductive electrodes, the accuracy of detecting the touch position is hard to guarantee in previous technology. The current invention in this case discloses a method of capacitance touch sensor architecture with adjustable resistance and noise reduction that can get a higher sensing accuracy.

### BRIEF DESCRIPTION OF THE DRAWINGS

FIG. 1 is a schematic illustration of previous technology.

FIG. 2 is a schematic illustration of sensor architecture with adjustable resistance and noise reduction.

FIG. 3 is a schematic illustration of the procedure of making the non-conductive barrier.

FIG. 4 is a schematic illustration of the signal strength without winding resistance.

FIG. 5 is a schematic illustration of the signal strength with winding resistance.

FIG. 6 is a schematic illustration of the effect of the addition sensor.

### DETAILED DESCRIPTION OF THE INVENTION

All illustrations of the drawings and description of embodiments are for the purpose of describing selected versions of the present invention and are not intended to limit the scope of the present invention.

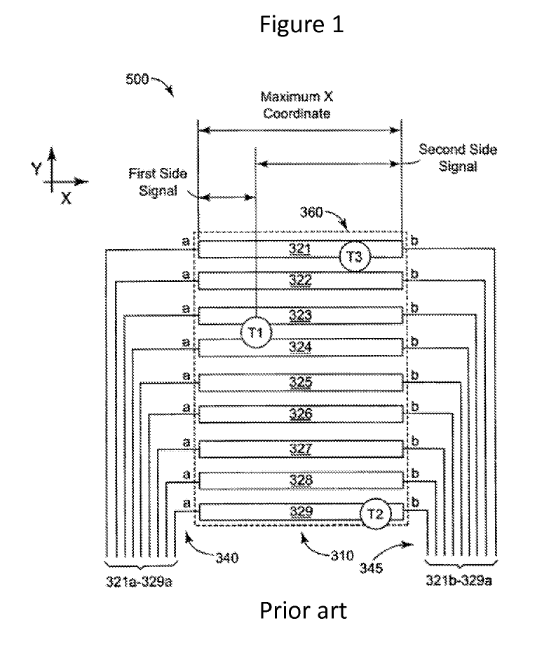

FIG. 1 illustrates the basic touch sensor architecture. As shown in FIGS. 1, 321 to 329 are strip capacity sensors. Sensor signal from end a is defined as first side signal and sensor signal from end b is defined as second side signal. In this embodiment, when a finger touch the T1 point, the resistance from end a to T1 is different from the resistance from end b to T1. There is difference between the first side signal and the second side signal. The coordinate of point T1 in x-axis can be calculated by the following equation. Wherein the XSpan is the scale factor that to zoom out to the screen resolution. The coordination of y-axis can be detected from the signals in wires 321a to 329a and in wires 321b to 329b.

$$\frac{XSpan \times FirstSideSignal}{FirstSideSignal + SecondSideSignal}$$

Literally, this method can calculate the location of touches while there are two drawbacks. The first is because of the limitation of resistance of Indium tin oxide (ITO), which used to make strip capacity sensors, the resistance from end a to end b of each strip capacity sensor is limited. In this case, when the two edge resisting rate are small, the difference between the first side signal and the second side signal would be very small, and the calculate result of the coordination in x-axis would be inaccuracy. When the two edge resisting rates are large, the first side signal may be saturated and the second side signal may approach to zero. This will cause the inaccuracy of the calculate result of the coordination in x-axis as well. The other drawback is the length of wires from 321a to 329a and the lengths of wires from 321b to 329b are different, which makes the resistance of those wires different, further, the signal in the wires will be influenced and there might be deviation when calculate the coordination in y-axis.

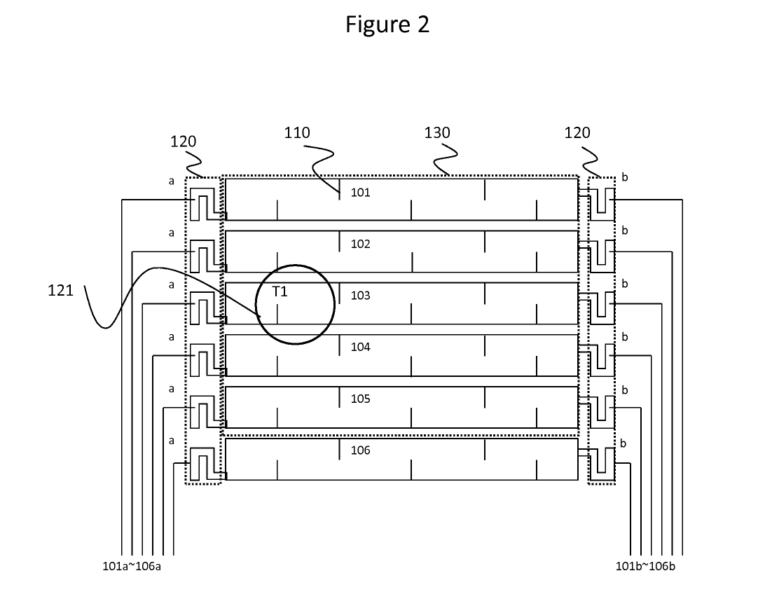

In order to overcome the drawbacks mentioned above, two key parts of the capacitive touch sensor architecture have been improved in the current invention. One is to add non-conductive barrier into strip capacity sensors to increase the edge resisting rate of them. The other is to add adjustable winding resistance to the two ends of each strip capacity sensors. Moreover, a reference sensor is added used in the current invention to eliminate environment noise. FIG. 2 shows a schematic illustration of sensor architecture in current invention with adjustable resistance and noise reduction.

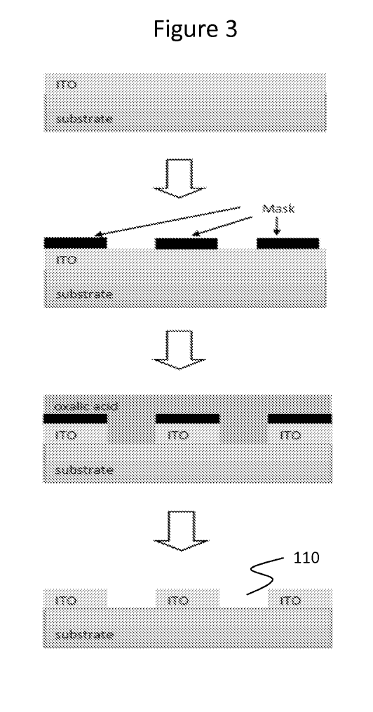

As shown in FIG. 2, the visible touch area 130 contains a plurality of strip capacity sensors made of transparent conductive material like Indium tin oxide (ITO). The non-conductive barriers 110 are made through etching or laser method to increase the edge resisting rate of strip capacity sensors. FIG. 3 shows the procedure of making the non-conductive barriers 110 by wet etching method. The strip capacity sensors are disposed on the substrate. Material cannot etched by acid is used to make a mask. The mask covers the area of the strip capacity sensors where need to be kept. Oxalic acid is used to etch the exposed part of the strip capacity sensors to form the non-conductive barriers 110. With those non-conductive barriers, the edge resisting rate of each strip capacity sensor is increased, which can increase the accuracy of measurement of coordination in x-axis. Adding the “etching” non-conductive barriers 110 inside the strip capacity sensors can not only increase the edge resisting rate, but do not changing the effective touch area.

The wire lengths are different of each strip capacity sensor as shown in FIG. 2. Longer wires have a higher resistance and higher resistance has lower signal strength. The error introduced by the difference of wire length will result in deviation of the coordinate in y-axis. In this case, the winding resistances 120 are introduced to compensate the resistance difference between 101a-106a and 101b-106b and increase the total resistance of each strip capacity sensor. The winding resistances 120 are attached to both sides of each strip capacity sensor to compensate resistance difference. The total resistance of each strip capacity sensor, the winding resistances connect to it, and the wires connect to it is fixed to a constant. In this case, the influence of length difference of the wires is eliminated.

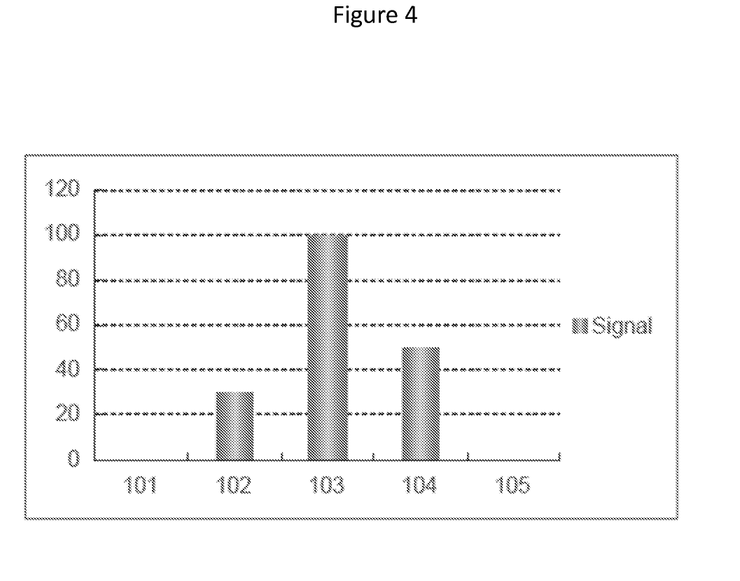

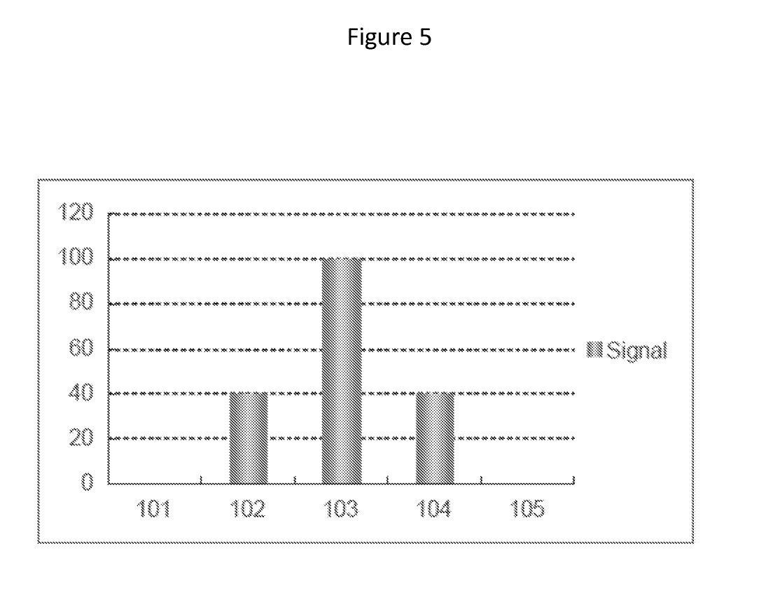

In order to illustrate the effect of the winding resistances 120, a touch point T1 121 is considered as an example. As shown in FIG. 2, area covered by T1 121 is the point touched by finger. Sensor 103 has the biggest contact area; sensor 102 and sensor 104 have the same contact area. The signal strength of sensor 102 and sensor 104 should be the same and that of sensor 103 should stronger. However due to the length difference of the wires, the signal strength of strip capacity sensor 102 and 104 would be different as shown in FIG. 4. The signal strength of sensor 104 is stronger than that of sensor 102 because of the wire length of sensor 104 is shorter than that of sensor 102, so sensor 104 has smaller resistance. This will result in deviation from the calculated Y position. By adding the winding resistance 120, different length of winding resistances are attaching to every strip capacity sensors accordingly to make sure each strip capacity sensor has the same resistance. FIG. 5 shows the signal strength in strip capacity sensor 102 to 104 with the winding resistances 120 and the Y position will become more accurate.

Environmental noise as known as ambient noise is always inevitable. The environmental noise might have a significant impact to the sensor signals especially when the signals are relatively small. In order to reduce the noise among the sensor signals, a reference strip capacity sensor is introduced to reduce noise influence while calculate touch coordinate. As shown in FIG. 2, strip capacity sensor 160 is added as a reference strip capacity sensor, which is outside of the visible touch area 130. All strip capacity sensors including reference strip capacity sensor 160 will exposed in the same environmental noise. While calculating the touch coordinate, the noise signal can be subtracted from the original sensor signals, wherein the signals in the reference strip capacity sensor 160 is the noise signals. The coordinate of touch point in x-axis can be calculated by the following equation, which reduces the impact of environmental noise.

$$\frac{XSpan \times ( 103 aSignal - 106 aSignal )}{( 103 aSignal - 106 aSignal ) + ( 103 bSignal - 106 bSignal )}$$

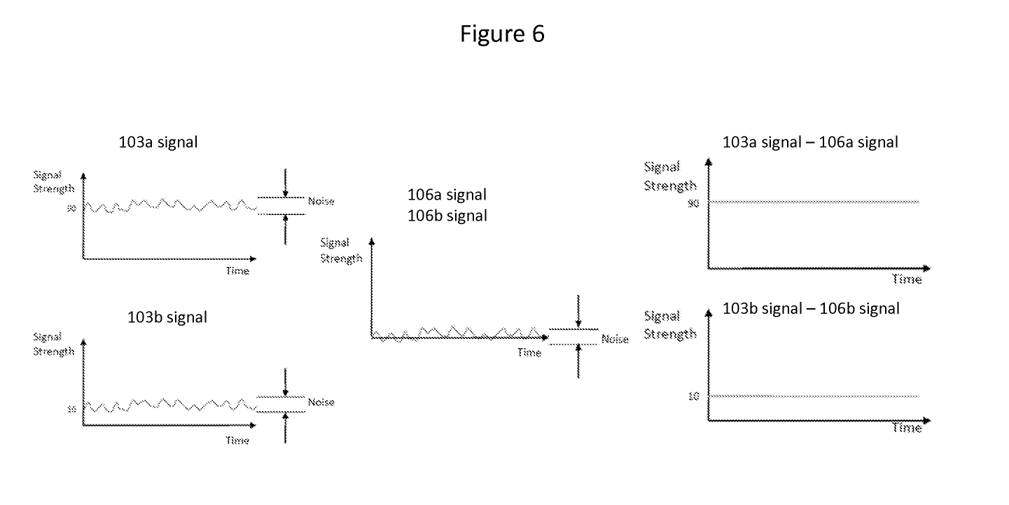

FIG. 6 shows the effect of adding the addition reference sensor. 103a signal is the signal of end a of the strip capacity sensor 103, 103b signal is the signal of end b of the strip capacity sensor 103. 106a signal is the signal of end a of the reference strip capacity sensor 160 and 106b signal is the signal of end b of the reference strip capacity sensor 160. For strip capacity sensors not touched, the signals in end a and end b should be zero if there is no noise. By subtracting the noise signals, stable strength of touch signals can be got. In this case, a relatively accurate coordinate of touch point in x-axis can be calculated no matter how small the sensor signals are.

In another embodiment, any one of the strip capacity sensors, 101 to 105 for instance, which is not touched within the visible touch area 130, can be used as the reference strip capacity sensor. The signal of untouched sensor is less than a constant threshold. Any strip capacity sensor satisfied with this condition can be chosen as the reference strip capacity sensor.

Although the invention has been explained in relation to its preferred embodiment, it is to be understood that many other possible modifications and variations can be made without departing from the spirit and scope of the invention as herein described.

What is claimed is:

1. A capacitive touch sensor architecture, comprising
a visible touch area;
a plurality of wires;
a plurality of winding resistances;
a reference strip capacity sensor;
said visible touch area comprises a plurality of strip capacity sensors;
said strip capacity sensors comprises end a and end b;
said strip capacity sensors comprises a plurality of non-conductive barriers;
said strip capacity sensors being used to sense touch signals to calculate touch point coordinate;
said winding resistances being attached to both sides of each said strip capacity sensor;
said each of wires being attached to each said winding resistance respectively; and
said wires have different length according to the position of each strip capacity sensor said wires being connected to.

2. The capacitive touch sensor architecture of claim 1, comprising
said strip capacity sensors being made of indium tin oxide (ITO).

3. The capacitive touch sensor architecture of claim 1, comprising
said strip capacity sensor being made of conductive polymer.

4. The capacitive touch sensor architecture of claim 1, comprising
said winding resistances being used to increase the resistance between end a to end b of each said strip capacity sensor;
said winding resistances have different resistance;
said winding resistances being used to compensate resistance difference caused by the length different of said wires; and
total resistance of each strip capacity sensor, said winding resistances connect with said strip capacity sensor, and wires connected to said winding resistances are the same.

5. The capacitive touch sensor architecture of claim 1, comprising
said plurality of non-conductive barriers being made by wet etching method;
said strip capacity sensors are disposed on the substrate;
material cannot being etched by acid being used to make a mask to cover area need to be kept of the strip capacity sensors;
oxalic acid being used to etch the exposed part of said strip capacity sensors to form said non-conductive barriers; and
said non-conductive barriers increases the edge resisting rate of each said strip capacity sensor.

6. The capacitive touch sensor architecture of claim 1, comprising
signals sensed by said reference strip capacity sensor being noise signals;
said reference strip capacity sensor being used to reduce noise; and
said noise signals being subtracted from said sense signals while calculating touch point coordinate.

7. The capacitive touch sensor architecture of claim 6, comprising
said reference strip capacity sensor being a strip capacity sensor located out of said visible touch area; and
said reference strip capacity sensor cannot been touched.

8. The capacitive touch sensor architecture of claim 6, comprising
said reference strip capacity sensor being a strip capacity sensor in said visible touch area; and
said reference strip capacity sensor being any one touched strip capacity sensor.

9. A capacitive touch sensor architecture, comprising
a visible touch area;
a plurality of wires;
a plurality of winding resistances;
a reference strip capacity sensor;
said visible touch area comprises a plurality of strip capacity sensors;
said strip capacity sensors comprises end a and end b;
said strip capacity sensors comprises a plurality of non-conductive barriers;
said strip capacity sensors being used to sense touch signals to calculate touch point coordinate;
said winding resistances being attached to both sides of each said strip capacity sensor;
said each of wires being attached to each said winding resistance respectively; and
said wires have different length according to the position of each strip capacity sensor said wires being connected to;
said winding resistances being used to increase the resistance between end a to end b of each said strip capacity sensor;
said winding resistances have different resistance;
said winding resistances being used to compensate resistance difference caused by the length different of said wires; and
total resistance of each strip capacity sensor, said winding resistances connect with said strip capacity sensor, and wires connected to said winding resistances are the same.

10. The capacitive touch sensor architecture of claim 9, comprising
said strip capacity sensors being made of indium tin oxide (ITO).

11. The capacitive touch sensor architecture of claim 9, comprising
said strip capacity sensor being made of conductive polymer.

12. The capacitive touch sensor architecture of claim 9, comprising
said plurality of non-conductive barriers being made by wet etching method;
said strip capacity sensors are disposed on the substrate;
material cannot being etched by acid being used to make a mask to cover area need to be kept of the strip capacity sensors;
oxalic acid being used to etch the exposed part of said strip capacity sensors to form said non-conductive barriers; and
said non-conductive barriers increases the edge resisting rate of each said strip capacity sensor.

13. The capacitive touch sensor architecture of claim 9, comprising
signals sensed by said reference strip capacity sensor being noise signals;
said reference strip capacity sensor being used to reduce noise; and
said noise signals being subtracted from said sense signals while calculating touch point coordinate.

14. The capacitive touch sensor architecture of claim 13, comprising
said reference strip capacity sensor being a strip capacity sensor located out of said visible touch area; and
said reference strip capacity sensor cannot been touched.

15. The capacitive touch sensor architecture of claim 13, comprising
said reference strip capacity sensor being a strip capacity sensor in said visible touch area; and
said reference strip capacity sensor being any one touched strip capacity sensor.

16. A capacitive touch sensor architecture, comprising
a visible touch area;
a plurality of wires;
a plurality of winding resistances;
a reference strip capacity sensor;
said visible touch area comprises a plurality of strip capacity sensors;
said strip capacity sensors comprises end a and end b;
said strip capacity sensors comprises a plurality of non-conductive barriers;
said strip capacity sensors being used to sense touch signals to calculate touch point coordinate;
said winding resistances being attached to both sides of each said strip capacity sensor;
said each of wires being attached to each said winding resistance respectively; and
said wires have different length according to the position of each strip capacity sensor said wires being connected to;
said winding resistances being used to increase the resistance between end a to end b of each said strip capacity sensor;
said winding resistances have different resistance;
said winding resistances being used to compensate resistance difference caused by the length different of said wires;
total resistance of each strip capacity sensor, said winding resistances connect with said strip capacity sensor, and wires connected to said winding resistances are the same;
said plurality of non-conductive barriers being made by wet etching method;
said strip capacity sensors are disposed on the substrate;
material cannot being etched by acid being used to make a mask to cover area need to be kept of the strip capacity sensors;
oxalic acid being used to etch the exposed part of said strip capacity sensors to form said non-conductive barriers;
said non-conductive barriers increases the edge resisting rate of each said strip capacity sensor;
signals sensed by said reference strip capacity sensor being noise signals;
said reference strip capacity sensor being used to reduce noise; and
said noise signals being subtracted from said sense signals while calculating touch point coordinate.

17. The capacitive touch sensor architecture of claim 16, comprising
said strip capacity sensors being made of indium tin oxide (ITO).

18. The capacitive touch sensor architecture of claim 16, comprising
said strip capacity sensor being made of conductive polymer

19. The capacitive touch sensor architecture of claim 16, comprising
said reference strip capacity sensor being a strip capacity sensor located out of said visible touch area; and
said reference strip capacity sensor cannot been touched.

20. The capacitive touch sensor architecture of claim 16, comprising
said reference strip capacity sensor being a strip capacity sensor in said visible touch area; and
said reference strip capacity sensor being any one touched strip capacity sensor.
